(19) United States
(12) Patent Application Publication
(10) Pub. No.: US 2005/0070146 A1
(43) Pub. Date: Mar. 31, 2005

(54) Memory card connector

(76) Inventor: Chiu-Ming Lu, Chung-Ho City (TW)

Correspondence Address: MOLEX INCORPORATED, 2222 WELLINGTON COURT, LISLE, IL, 60532, US

(21) Appl. No.: 10/945,191

(22) Filed: Sep. 20, 2004

(30) Foreign Application Priority Data
Sep. 26, 2003 (TW) 92217343

(51) Int. Cl. H01R 13/62

(52) U.S. Cl. 439/326

(57) ABSTRACT

A memory card connector is provided for receiving a memory card having a plurality of conductive contacts. The connector includes an insulating housing having a receptacle for receiving the memory card. A plurality of conductive terminals are mounted on the housing. A cover is provided for covering the receptacle and the memory card received therein. A pivot is engageable between the cover and the housing to mount the cover for pivotal movement between an open position to allow the memory card to be placed in the receptacle and a closed position bringing the contacts of the memory card into engagement with the terminals on the housing. A latch is engageable between the cover and the housing to allow the cover to slidably move from its closed position to a latched position whereat the cover is prevented from pivoting back to its open position. A lock is engageable between the cover and the housing to inhibit the cover from sliding from its latched position back to the closed position.

### FIELD OF THE INVENTION

This invention generally relates to the art of electrical connectors and, particularly, to a memory card connector. The invention is specifically directed to a memory card connector which includes a cover and an improved means for pivotally and slidably mounting the cover to the connector housing.

### BACKGROUND OF THE INVENTION

Memory cards are known in the art and contain intelligence in the form of a memory circuit or other electronic program. Some form of card reader reads the information or memory stored on the card. Such cards are used in many applications in today's electronic society, including video cameras, digital still cameras, smartphones, music players, ATMs, cable television decoders, toys, games, PC adapters, multi-media cards and other electronic applications. Typically, a memory card includes a contact or terminal array for connection through a card connector to a card reader system and then to external equipment. The connector readily accommodates insertion and removal of the card to provide quick access to the information and program on the card. The card connector includes terminals for yieldingly engaging the contact array of the memory card.

For instance, a portable telephone is provided with a memory card (SIM card) capable of storing such information as a telephone number, melody information of incoming sound or the like along with subscriber identification information. The SIM card can be inserted into and withdrawn from a memory card connector attached to a main body of the portable telephone. When the SIM card is inserted into the card connector, the information stored on the card can be used. Therefore, even in the case of interchanging a portable telephone with a new telephone, it is not necessary for a user to write or rewrite new information on a SIM card.

A typical memory card connector is provided with a dielectric housing in the form of a base on which the contacts or terminals are mounted. A cover is attached to the base and is movable between an open position and a closed position relative to the base. A memory card is inserted into the cover when the cover is in its open position, and the cover and memory card then can be moved relative to the base to bring the contacts on the card into engagement with the terminals on the base. An example of such a card connector is shown in FIGS. 1 and 2. Specifically, FIGS. 1 and 2 show a conventional memory card (SIM card) connector, generally designated 10, which includes an insulating base or housing, generally designated 12, and a cover, generally designated 14. The base may be molded of plastic material, and the cover may be stamped and formed of sheet metal material. A plurality of conductive terminals 16 are mounted on the base. The terminals have tail portions 16a for connection, as by soldering, to appropriate circuit traces on a printed circuit board, such as a board mounted in a mobile telephone. The cover is assembled to the base in the direction of arrow “A” (FIG. 1) to a mounted position shown in FIG. 2. A memory or SIM card, generally designated 18, is mounted in the cover in the direction of arrow “B” (FIG. 1) to an installed position shown in FIG. 2. The cover then is pivoted downwardly in the direction of arrow “C” (FIG. 2) to a closed position (not shown) whereat a plurality of conductive contacts 18a on the memory card are brought into engagement with terminals 16 mounted on the body.

Base 12 of prior art connector 10 includes a generally flat body 12a having two notches 20 in each side edge thereof. A ledge 22a is formed at the bottom front corner of each notch. A pair of pivot arms 22 project rearwardly from opposite sides of the body. Each pivot arm has a pivot socket 22a in its outer face.

Metal shell 14 includes a top wall 14a and a pair of side walls 14b. A pair of side flanges 24 are bent or turned inwardly from each side wall. A pair of pivot arms 26 extend generally parallel to top wall 14a, as extensions of the side walls of the cover. A pivot boss 26a projects inwardly from the distal end of each pivot arm. Finally, a pair of card-mounting flanges 14c are formed at opposite ends of top wall 14a. The mounting flanges, in conjunction with side flanges 24, mount memory card 18 to the underside of the cover as shown in FIG. 2.

When cover 14 is assembled to base 12 in the direction of arrow “A” (FIG. 1), pivot arms 26 of the stamped and formed sheet metal cover spread outwardly until pivot bosses 26a “snap” into pivot sockets 22a of the base. After memory card 18 is mounted within the underside of the cover, the cover is pivoted downwardly about pivot bosses 26a in the direction of arrow “C” (FIG. 2) to its closed position (not shown). As the cover moves to its closed position, side flanges 24 of the cover move into notches 20 of the base. The cover then is slidably moved forwardly, whereupon side flanges 24 move under ledges 22a of the base to prevent the cover from pivoting back upwardly.

Prior art memory card connectors as described in relation to FIGS. 1 and 2 have a number of disadvantages. For instance, it is difficult to form pivot bosses 22a in a stamping and forming process due to the very small dimensions of the connector components, including cover 14, as well as the thinness of the sheet metal material of the cover. In addition, when the memory or SIM card is mounted within the underside of the cover, the sharp edges of the side walls and flanges of the cover tend to scrape or scratch the memory card. The edges can even cut the fingers of an operator. When the card is slidably moved with the cover, the foil on the bottom surface of the card is scraped or scratched by the conductive terminals 16 in base 12. The present invention is directed to solving various problems of the prior art including those described above.

### SUMMARY OF THE INVENTION

An object, therefore, of the invention is to provide a new and improved memory card connector of the character described.

In the exemplary embodiment of the invention, a memory card connector is provided for receiving a memory card having a plurality of conductive contacts. The connector includes an insulating housing having a receptacle for receiving the memory card. A plurality of conductive terminals are mounted on the housing. A cover is provided for covering the receptacle and the memory card received therein. Pivot means are engageable between the cover and the housing to mount the cover for pivotal movement between an open position to allow the memory card to be placed in the receptacle and a closed position bringing the contacts of the memory card into engagement with the terminals on the housing. Latch means are engageable between the cover and the housing to allow the cover to slidably move from its closed position to a latched position whereat the cover is prevented from pivoting back to its open position. Lock means are engageable between the cover and the housing to inhibit the cover from sliding from its latched position back to the closed position.

According to one aspect of the invention, the pivot means comprise a pair of pivot posts on the housing received in a pair of pivot holes in the cover. The receptacle is bounded by a pair of side walls of the cover, and the pivot posts protrude outwardly of the side walls. The pivot holes are formed in a pair of pivot arms at one end of the cover, and the holes are elongated to accommodate the sliding movement of the cover between its closed position and its latched position.

According to another aspect of the invention, the latch means comprises a first latching flange on the cover slidable under a second latching flange on the housing when the cover slides to its latched position. The first latching flange is part of an L-shaped latch structure on the cover. One leg of the L-shaped structure is a support leg and the other leg of the L-shaped latch structure comprises the first latching flange.

According to a further aspect of the invention, the lock means comprises a locking recess on the housing for receiving a locking boss on the cover. In the preferred embodiment, the locking boss is on the one leg of the L-shaped latch structure, whereby the latch structure performs a dual function of latching the cover in its latched position as well as locking the cover in the latched position.

Other objects, features and advantages of the invention will be apparent from the following detailed description taken in connection with the accompanying drawings.

### BRIEF DESCRIPTION OF THE DRAWINGS

The features of this invention which are believed to be novel are set forth with particularity in the appended claims. The invention, together with its objects and the advantages thereof, may be best understood by reference to the following description taken in conjunction with the accompanying drawings, in which like reference numerals identify like elements in the figures and in which:

FIGS. 1 and 2 are perspective views of the prior art connector described in the Background, above;

FIG. 3 is an exploded perspective view of the memory card connector according to the invention;

FIG. 3A is an enlarged depiction of the area encircled at “A” in FIG. 3, and rotated 90°;

FIG. 4 is a perspective view of the connector of FIG. 3 in assembled condition, with the cover in its open position;

FIG. 5 is a view similar to that of FIG. 4, with the memory card in the process of being placed into the housing;

FIG. 6 is a view similar to that of FIG. 5, with the memory card fully inserted into the housing;

FIG. 7 is a perspective view of the connector, with the cover pivoted to its closed position;

FIG. 8 is a view similar to that of FIG. 7, with the cover slidably moved to its latched position; and

FIGS. 9 and 10 are enlarged, fragmented side elevation views of the latch/lock structure at each side edge of the connector housing, showing sequential views of the memory card (in phantom) moving from its closed position (FIG. 9) to its latched position (FIG. 10).

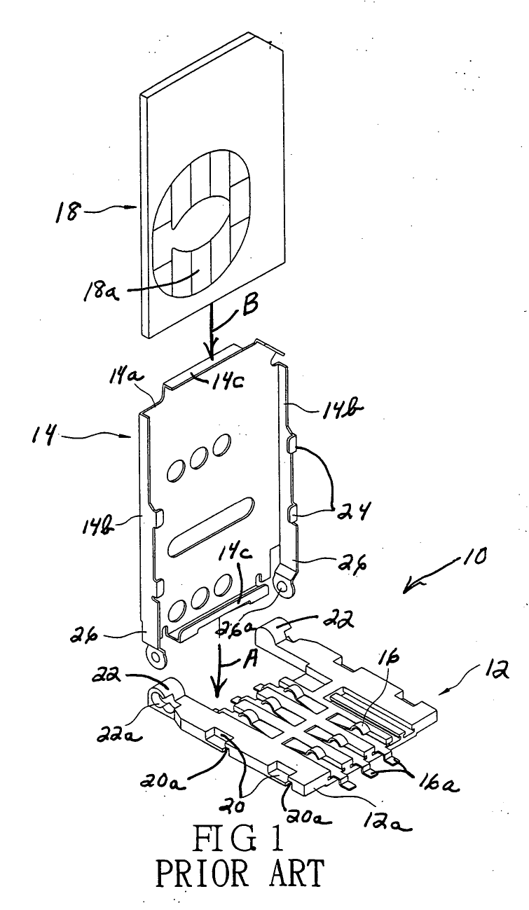

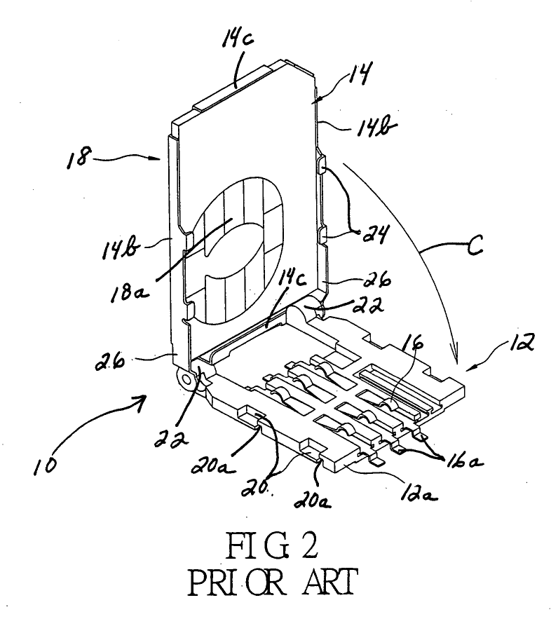

### DETAILED DESCRIPTION OF THE PREFERRED EMBODIMENT

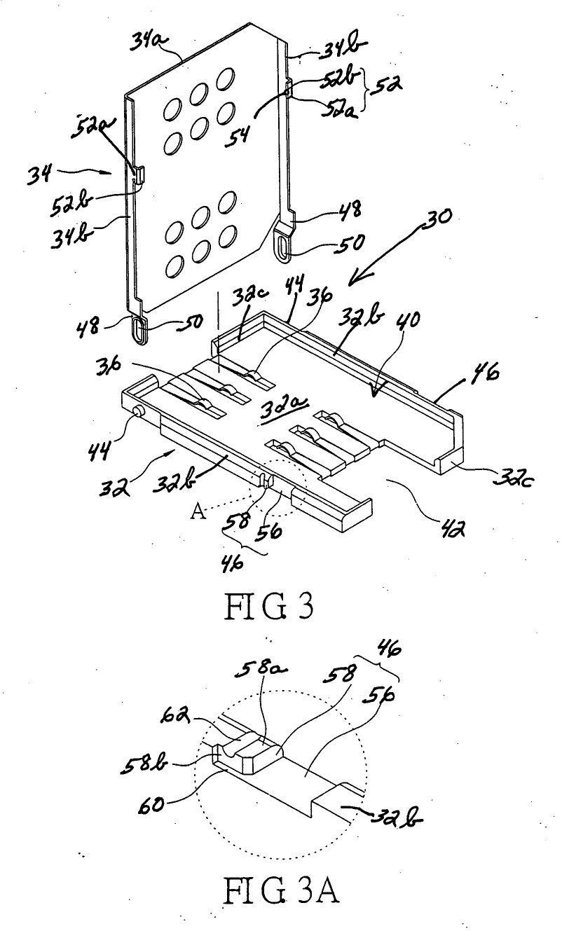

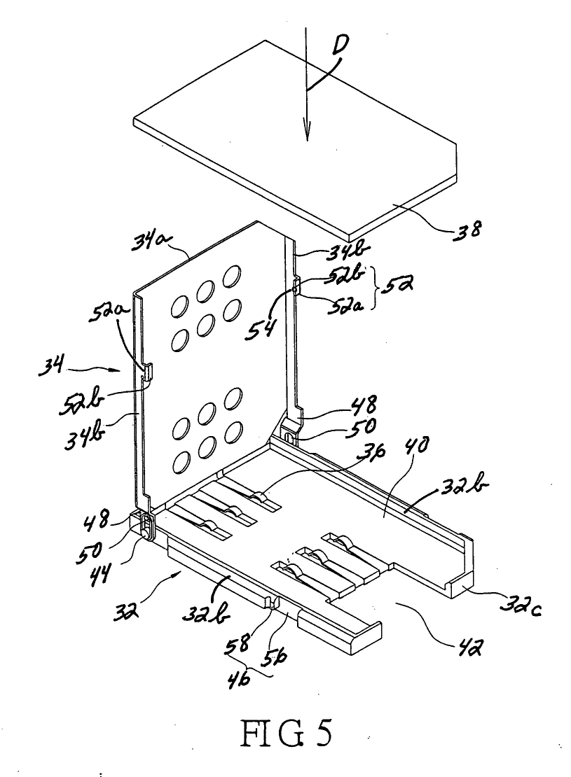

Referring to the drawings in greater detail, and first to FIG. 3, the invention is embodied in a memory card connector, generally designated 30, which includes a housing, generally designated 32, and a cover, generally designated 34. The housing mounts a plurality of conductive terminals 36. The housing may be a one-piece structure molded of dielectric material such as plastic or the like. The cover may be stamped and formed of sheet metal material. Card connector 30 may be mounted on a base of a portable telephone for receiving a memory or SIM card 38 (FIG. 5). However, it should be understood that the card connector shown herein is applicable for a wide range of uses other than portable telephones, as pointed out in the “Background”, above.

Housing 32 of connector 30 includes a generally flat, rectangular bottom wall 32a, a pair of side walls 32b and end walls 32c. The side and end walls are upstanding walls about the periphery of the bottom wall and define a receptacle, generally designated 40, for receiving the memory card. A cut-out 42 is formed in the front edge of bottom wall 32a through front wall 32c to allow for easy grasping of the memory card. A pair of pivot bosses project outwardly from side walls 32b near the rear ends thereof. Finally, a latch/lock structure 46 is molded integrally in the outside faces of each side wall, as described in greater detail hereinafter.

Cover 34 of connector 30 includes a top wall 34a and a pair of side walls 34b. A pair of pivot arms 48 extend generally parallel to the top wall, as extensions of the side walls. An elongated pivot hole 50 is formed in each pivot arm. An L-shaped latch structure 52 is stamped and formed along the edge of each side wall 34b of the cover. The L-shaped structure includes one leg 52a which forms a support leg, and a second leg 52b which forms a latching flange. A locking boss 54 is stamped and formed out of support leg 52a of each latch structure 52 to project inwardly of the cover.

Referring to FIG. 3A in conjunction with FIG. 3, each latch/lock structure in the outer face of each side wall 32b of housing 32 includes a notch 56 and a latch/lock block 58. The block has an outer surface 58a and a bottom surface 58b. The bottom surface is offset from the bottom surface of the side wall to form a latching recess 60. In essence, bottom wall 58b of latch/lock block 58 forms a latching flange. A locking recesses in the form of a groove 62 is formed in the outer surface 58a of block 58.

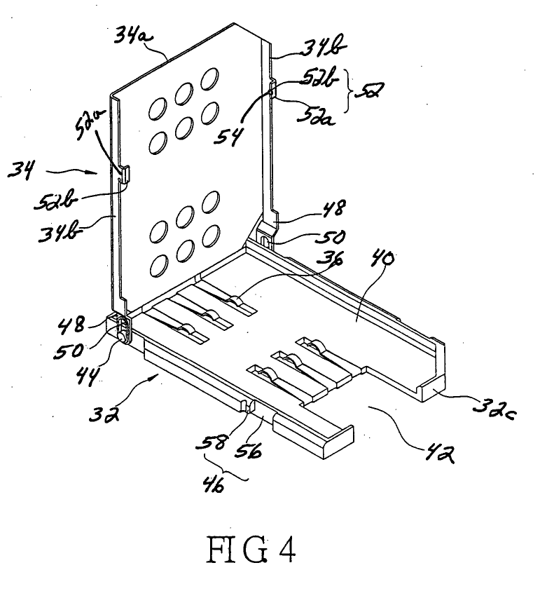

FIG. 4 shows cover 34 assembled to housing 32. During assembly, pivot arms 48 can be spread outwardly due to the resiliency of the sheet metal material so that pivot bosses 44 on the cover can “snap” into the elongated pivot holes in the pivot arms.

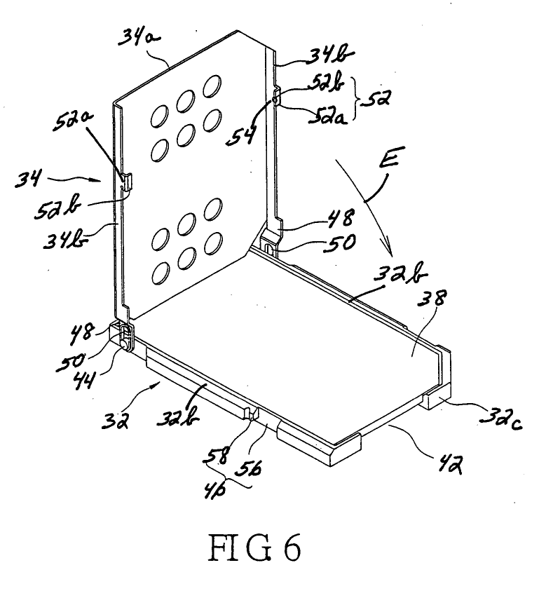

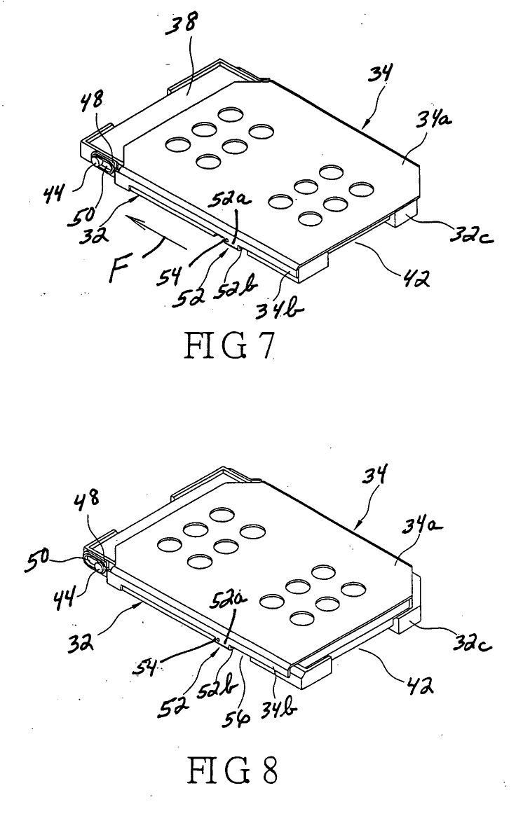

Once the cover is assembled to the housing, memory or SIM card 38 can be placed within receptacle 40 of the housing in the direction of arrow “D” (FIG. 5). FIG. 6 shows the card placed into the receptacle of the housing whereupon cover 34 can be pivoted in the direction of arrow “E” (FIG. 6) from its open position shown in FIG. 6 to its closed position shown in FIG. 7. As the cover moves to its closed position, latch structures 52 on side walls 32b of the cover move into notches 56 in the outside faces of side walls 32b of the housing.

After cover 34 is pivoted to its closed position shown in FIG. 7, the cover can be slidably moved in the direction of arrow “F” to a latched position shown in FIG. 8. When the cover moves to its latched position, latching flanges 52b of the cover slidably move into latching recesses 60 (FIG. 3A) and under latching flanges 58b at the side walls of the housing. Elongated pivot holes 50 in the cover which receive pivot bosses 44 of the housing accommodate this sliding movement of the cover.

In the latched position of FIG. 8, the cover also is locked by means of locking bosses 54 at the insides of support legs 52a of the cover snapping into locking engagement within locking recesses 62 (FIG. 3A) in the outside faces of the side walls of the housing.

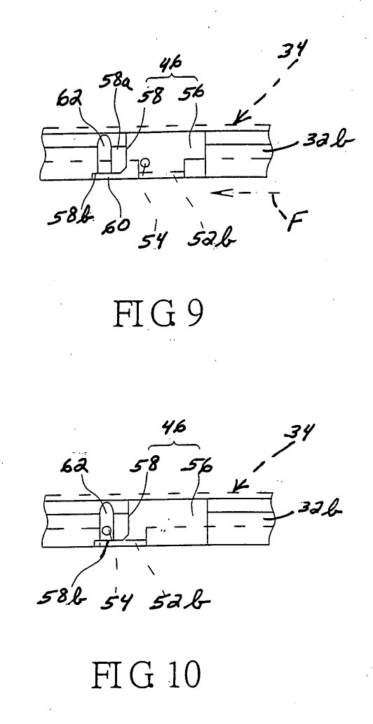

FIGS. 9 and 10 show cover 34 in phantom and illustrates its sliding movement in the direction of arrow “F” from its closed position shown in FIG. 9 to its latched and locked position shown in FIG. 10. In its closed position of FIG. 9, latching flange 52b has pivoted with the cover into notch 56 in the outside face of side wall 32b. When the cover moves in the direction of arrow “F” from its closed position (FIG. 9) to its latched and locked position (FIG. 10), latching flange 52b of the cover moves under latching flange 58b of the housing to prevent the cover from pivoting back upwardly toward its open position. In addition, locking boss 54 on the cover moves into locking recess 62 of the housing to inhibit the cover from sliding from its latched position (FIG. 10) back to its closed position (FIG. 9).

When it is desired to open connector 30 to remove and/or replace the memory (SIM) card, the cover is forced back from its latched and locked position of FIG. 10 to its closed position of FIG. 9. This forces locking bosses 54 out of locking recesses 62 and moves latching flanges 52 of the cover back into alignment with notches 56 in the housing. The cover then can be simply lifted or pivoted upwardly from its closed position to its open position of FIG. 6, whereupon the memory card can be lifted out of receptacle 40.

It will be understood that the invention may be embodied in other specific forms without departing from the spirit or central characteristics thereof. The present examples and embodiments, therefore, are to be considered in all respects as illustrative and not restrictive, and the invention is not to be limited to the details given herein.

1. A memory card connector for receiving a memory card having a plurality of conductive contacts, comprising:
an insulating housing having a receptacle for receiving the memory card;
a plurality of conductive terminals mounted on the housing;
a cover for covering the receptacle and the memory card received therein;
pivot means engageable between the cover and the housing to mount the cover for pivotal movement between an open position to allow the memory card to be placed in the receptacle and a closed position bringing the contacts of the memory card into engagement with the terminals on the housing;
latch means engageable between the cover and the housing to allow the cover to slidably move from said closed position to a latched position whereat the cover is prevented from pivoting back to its open position; and
lock means engageable between the cover and the housing to inhibit the cover from sliding from its latched position back to the closed position.

2. The memory card connector of claim 1 wherein said pivot means comprise a pair of pivot posts on the housing received in a pair of pivot holes in the cover.

3. The memory card connector of claim 2 wherein the receptacle of the housings bounded by a pair of side walls, and said pivot posts protrude outwardly of the side walls.

4. The memory card connector of claim 3 wherein said pivot holes are formed in a pair of pivot arms at one end of the cover.

5. The memory card connector of claim 2 wherein said pivot holes are elongated to accommodate said sliding movement of the cover between its closed position and its latched position.

6. The memory card connector of claim 1 wherein said latch means comprises a first latching flange on the cover slidable under a second latching flange on the housing when the cover slides to said latched position.

7. The memory card connector of claim 6 wherein said first latching flange is part of an L-shaped latch structure on the cover, one leg of the L-shaped structure being a support leg and the other leg of the L-shaped latch structure comprising the first latching flange.

8. The memory card connector of claim 1 wherein said lock means comprises a locking recess on the housing for receiving a lock boss on the cover.

9. A memory card connector for receiving a memory card having a plurality of conductive contacts, comprising:
an insulating housing having a receptacle for receiving the memory card;
a plurality of conductive terminals mounted on the housing;
a cover for covering the receptacle and the memory card received therein;
pivot means engageable between the cover and the housing to mount the cover for pivotal movement between an open position to allow the memory card to be placed in the receptacle and a closed position bringing the contacts of the memory card into engagement with the terminals on the housing; and
a singular latch/lock structure performing a dual function of having a latch means engageable between the cover and the housing to allow the cover to slidably move from said closed position to a latch position, and lock means engageable between the cover and the housing to inhibit the cover from sliding from its latched position back to the closed position.

10. The memory card connector of claim 9 wherein said pivot means comprise a pair of pivot posts on the housing received in a pair of pivot holes in the cover.

11. The memory card connector of claim 10 wherein the receptacle of the housing is bounded by a pair of side walls, and said pivot posts protrude outwardly of the side walls.

12. The memory card connector of claim 11 wherein said pivot holes are formed in a pair of pivot arms at one end of the cover.

13. The memory card connector of claim 10 wherein said pivot holes are elongated to accommodate said sliding movement of the cover between its closed position and its latched position.

14. The memory card connector of claim 9 wherein said singular latch/lock structure includes a singular latch/lock flange structure on the cover including a latching flange slidable under a latching flange on the housing when the cover slides to the latch position and a locking boss on the flange structure engageable in a locking recess in the housing.

15. The memory card connector of claim 14 wherein said singular latch/lock flange structure on the cover is generally L-shaped, with one leg of the L-shaped structure being a support leg and the other leg of the L-shaped structure comprising the latching flange on the cover.

16. The memory card connector of claim 15 wherein said locking boss is on the support leg of the L-shaped structure.

17. The memory card connector of claim 9 wherein said singular latch/lock structure includes a single block on the housing which has a first surface to define a latching flange for engaging a latching flange on the cover when the cover slides to said latched position, and a locking recess on the block for engaging a locking projection on the cover.

18. A memory card connector for receiving a memory card having a plurality of conductive contacts, comprising:
an insulating housing having a receptacle for receiving the memory card;
a plurality of conductive terminals mounted on the housing;
a cover for covering the receptacle and the memory card received therein;
pivot means engageable between the cover and the housing to mount the cover for pivotal movement between an open position to allow the memory card to be placed in the receptacle and a closed position bringing the contacts of the memory card into engagement with the terminals on the housing;
latch means engageable between the cover and the housing to allow the cover to slidably move from said closed position to a latched position whereat the cover is prevented from pivoting back to its open position; and
said pivot means comprising a pair of pivot posts on one of the housing or the cover received in a pair of pivot holes in the other of the housing or the cover, the pivot holes being elongated to accommodate said sliding movement of the cover between its closed position and its latched position.

19. The memory card connector of claim 18 wherein the receptacle of the housing is bounded by a pair of side walls, and said pivot posts protrude outwardly of the side walls.

20. The memory card connector of claim 19 wherein said pivot holes are formed in a pair of pivot arms at one end of the cover.
